(19) United States
(12) Patent Application Publication
(10) Pub. No.: US 2019/0114862 A1
(43) Pub. Date: Apr. 18, 2019

(54) MONEY ITEM CANISTER

(71) Applicant: Crane Payment Innovations, Inc., Malvern, PA (US)

(72) Inventors: Robert James BLYTHIN, Shropshire (GB); Graham Richard JONES, Lancashire (GB)

(73) Assignee: Crane Payment Innovations, Inc., Malvern, PA (US)

(21) Appl. No.: 16/082,514

(22) PCT Filed: Aug. 22, 2017
(86) PCT No.: PCT/US2017/048062

§ 371 Date: Sep. 5, 2018

Related U.S. Application Data
(60) Provisional application No. 62/378,200, filed on Aug. 22, 2016.

(51) Int. Cl. G07D 3/12; G07D 1/00

(52) U.S. Cl. CPC G07D 3/128; G07D 1/00

(57) ABSTRACT

An embodiment of this disclosure provides a money item dispensing apparatus comprising: a money item track operable to receive a money item and transport the money item, a denominator configured to determine a denomination of the money item on the money item track, a rotatable money item canister operable to receive the money item in a tube of a plurality of tubes, and a diverter gate configured to divert the money item to the tube, the tube corresponding to the denomination of the money item.

### CROSS-REFERENCE TO RELATED APPLICATIONS

The present application is a 371 of International Application No. PCT/US2017/048062, filed Aug. 22, 2017, which claims priority to U.S. Provisional Application No. 62/378,200, filed Aug. 22, 2016, the disclosures of which are incorporated herein by reference in their entireties.

### TECHNICAL FIELD

This disclosure relates generally to a money item canister. More specifically, this disclosure relates to a money item canister for a money item dispensing system with a reduced space envelope.

### BACKGROUND

Currently, in products that use money item tubes, different denominations are sorted into these separate tubes via individual gates. When using individual gates, extra activation methods are needed for these gates (motor or solenoid), which adds to the cost and takes up valuable space. The payout orientation of these tubes can also be fixed; therefore the system always has to pay out from the individual tubes down the same fixed path.

### SUMMARY

This disclosure provides a money item canister for a money item dispensing system with a reduced space envelope.

An embodiment of this disclosure provides a money item dispensing apparatus comprising: a money item track operable to receive a money item and transport the money item; a denominator configured to determine a denomination of the money item on the money item track; a rotatable money item canister operable to receive the money item in one of a plurality of tubes; and a diverter gate configured to divert the money item to the tube, the tube corresponding to the denomination of the money item.

Other technical features may be readily apparent to one skilled in the art from the following figures, descriptions, and claims.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1A illustrates a money item dispensing system with a money item canister 105 according to various embodiments of the present disclosure;

FIG. 1B illustrates a money item dispensing system with money items released from the money item canister according to various embodiments of the present disclosure

FIG. 2 illustrates an example computing device supporting a money item dispensing system according to this disclosure;

FIGS. 3A and 3B illustrate a money item canister according to various embodiments of the present disclosure;

FIG. 4A illustrates a money item dispensing system with a multiple tube manifold sorter 405 according to various embodiments of the present disclosure;

FIG. 4B illustrates the use of multiple solenoids to sort money items in a multiple tube manifold sorter from single diverter gate according to an embodiment of this disclosure;

FIG. 5 illustrates an example process accepting money items using a money item dispensing system according to various embodiments of the present disclosure; and

FIG. 6 illustrates an example process returning money items using a money item dispensing system according to various embodiments of the present disclosure.

### DETAILED DESCRIPTION

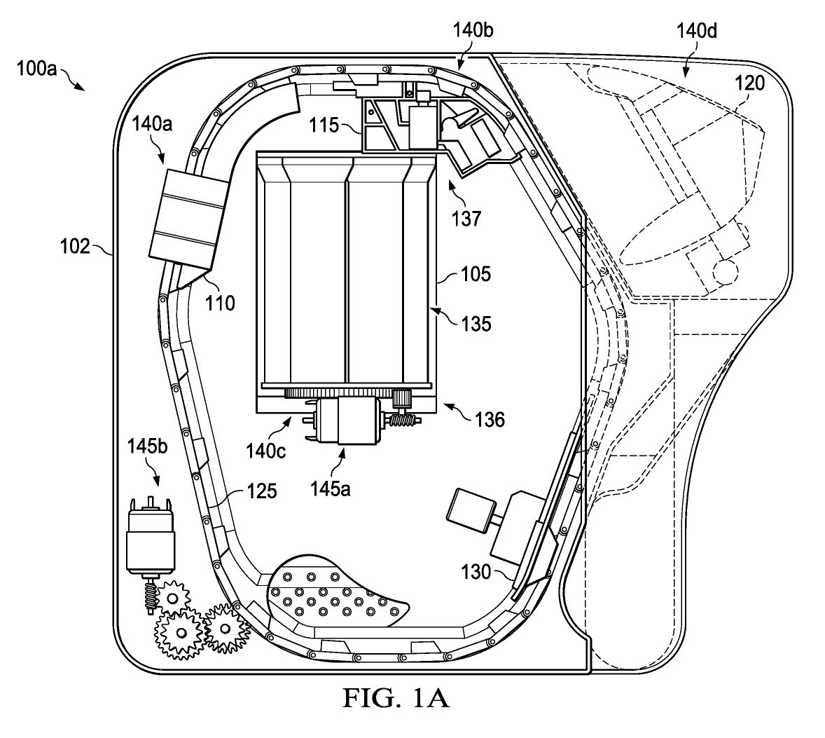

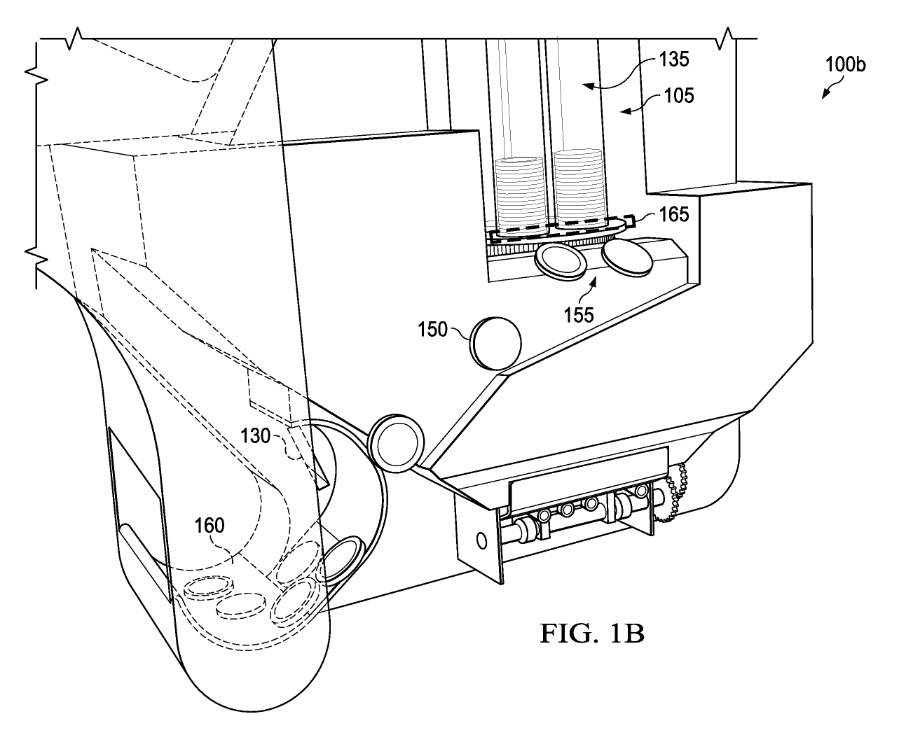

FIGS. 1A through 6, discussed below, and the various embodiments used to describe the principles of the present invention in this patent document are by way of illustration only and should not be construed in any way to limit the scope of the disclosure. Those skilled in the art will understand that the principles of this disclosure may be implemented in any suitably arranged device or system.

The purpose of this disclosure is the ability to pay money items from multiple, single denomination tubes that act as individual hoppers in a small space envelope. Embodiments of this disclosure allow for making a mixed denomination money item recycler in the smallest possible space envelope so that it could be placed on table tops in small retailers, fast food environments or other applications where space is at a premium.

FIG. 1A illustrates a money item dispensing system 100a with a money item canister 105 according to various embodiments of the present disclosure. The embodiment of the money item dispensing system 100a illustrated in FIG. 1A is for illustration only. FIG. 1A does not limit the scope of this disclosure to any implementation of a money item dispensing system.

In an embodiment, the money item dispensing system 100a includes a chassis 102, a money item canister 105, a denominator 110, a diverter gate 115, a validator 120, a money item track 125, a money item track exit 130, tubes 135, a processing devices 140a-d, and a motor 145a-b. The money item dispensing system 100a receives money items and returns change in money items. The money item dispensing system 100a is designed with a reduced profile to fit into a small space envelope. In certain embodiments, the chassis 102 contains money item canister 105, denominator 110, diverter gate 115, validator 120, a money item track 125, a money item track exit 130, tubes 135, processing devices 140a-d, and motor 145a-b. The money item can be a coin, token, slug, washer or any other item that could be used in an attempt to operate a money item operated device or system. The validator 120 is configured to receive and reject money items.

In different embodiments, various components of system 100a can include a processing device. In this example embodiment, each of money item canister 105, a denominator 110, a diverter gate 115, and a validator 120 include processing devices 140a-d. In another example, only some of money item canister 105, a denominator 110, a diverter gate 115, and a validator 120 include a processing device. A master processing device may also be included in system 100a. The master processing device can be positioned within chassis 102 or external to chassis 102. The master processing device may be connected to some or all of money item canister 105, a denominator 110, a diverter gate 115, and a validator 120. When using a master processing device, in one example embodiment, none of money item canister 105, a denominator 110, a diverter gate 115, and a validator 120 may include an internal processing device. As discussed herein, it is understood that communication between money item canister 105, a denominator 110, a diverter gate 115, and a validator 120 are performed by processing devices or through a master processing device that controls each of money item canister 105, a denominator 110, a diverter gate 115, and a validator 120. In other example, when using a master processing device, one or more of money item canister 105, a denominator 110, a diverter gate 115, and a validator 120 may include internal processing devices.

Reference to a component of system 100a sending a signal to another component of system 100a, can imply that the signal is being sent and received by processing devices of the components. For example, a reference to denominator 110 sending a signal to gate 115 can be interpreted as processing device 140a sending a signal to processing device 140b. In another example, a reference to denominator 110 sending a signal to gate 115 can be interpreted as the denominator 110 sending a signal to gate 115 via a master processing device, where denominator 110 and the gate 115 may or may each have a processing device.

The money item canister 105 is illustrated with six tubes 135. Depending on the type of currency, each tube 135 is assigned a dedicated money item. Currencies with more than six money items may use a separate storage for rare, or infrequently used, money items or remain on the money item track 125. In another embodiment, the money item canister 105 can be structured with more or less tubes depending on the currency and usage.

The money item canister 105 is further configured with a processing device 140c. In certain embodiments, the processing device 140c is configured to transmit signals to any other processing device 140a,b,d located within the money item dispensing system 100a. In certain embodiments, the processing device 140c is configured to receive signals from any other processing device 140a,b,d located within the money item dispensing system 100a. for example, the processing device 140c may receive a signal from processing device

The money item canister 105 is further configured with a motor 145a. In certain embodiments, the motor 145a is configured to facilitate rotation around a vertical axis. In certain embodiments, the motor 145a is configured to facilitate rotation of money item canister 105 a predetermined number of degrees around the vertical axis based on the signal received from, for example, the processing device 140a. In other embodiment, the rotation signal can be received from another component of system 100a, such as a master processing device. The vertical axis can be from a bottom 136 of tubes 135 to a top 137 of tubes 135.

The money items received by the money item dispensing system 100a are separated and transported using the money item track 125. The money item track 125 travels around the inside perimeter of the money item dispensing system 100a. Motor 145b uses gears to engage and outward side of the money item track 125 and cause the money item track 125 to move. The side of the money item track 125 facing inward has a plurality of bumps, or grooves, that catch a money item inserted into the money item dispensing system 100a. When a large amount of money items is inserted, the bumps in the money item track 125 are configured to separate and transport each money item separately.

The money item track 125 takes each money item through the denominator 110 to determine the denomination of each money item. The money item dispensing system 100a is programmed with profiles for the money items to identify the denominations as they pass through the denominator 110.

In one example embodiment, the denominator 110 is configured with the processing device 140a. In certain embodiments, the processing device 140a is configured to transmit signals to any other processing device 140b-d located within the money item dispensing system 100a. In certain embodiments, the processing device 140a is configured to receive signals from any other processing device 140b-d located within the money item dispensing system 100a. The denominator 110 transmits the denomination of each money item to the money item canister 105 and diverter gate 115 via the processing device 140.

The diverter gate 115 is configured with a processing device 140b. In certain embodiments, the processing device 140a,c,d is configured to transmit signals to any other processing device 140 located within the money item dispensing system 100a. In certain embodiments, the processing device 140b is configured to receive signals from any other processing device 140a,c,d located within the money item dispensing system 100a. The diverter gate 115 is programmed to redirect money items from the money item track 125 based on a signal received at the processing device 140b from the denominator 110.

As each money item on the money item track 125 approaches the diverter gate 115, the money item canister 105 is rotated via a motor 145a to align a tube 135 to the diverter gate 115 corresponding to the transmitted denomination from denominator 110. The diverter gate 115 redirects the money item off from the money item track 125 into the tube 135. Instead of having six gates for six different money item storage units, only one diverter gate 115 is required to reduce the profile of the money item dispensing system 100a.

In certain embodiments, currencies could have six or less type of money items and still have a separate storage for rare money items. For example, rare money items can remain on money item track 125. In one embodiment, the denominator 110 can send a signal to the diverter gate 115 to prevent the rare money items from being diverted to the tubes 135 and instead remain on the money item track 125.

In various embodiments, the tubes 135 can also be assigned to specific denominations based on likelihood of usage when making change to return to the user. Multiple tubes 135 can be assigned to a money item denomination with a high likelihood of usage for making change. For example, quarters could have a high likelihood of usage for making change in U.S. currency. Thus, two tubes 135 could be used to accept and return quarters compared to a single tube for other denominations.

In one or more embodiments, some money item dispensing systems 100a can be programmed to exclude specific denominations of currencies. For example, some money item dispensing systems 100a are used with products/services that have prices rounded to the nearest five or ten cents. If the prices are round to the nearest five cents, then denominations, e.g., pennies, valued at less than five cents would not be required for change. The money item dispensing system 100 could also contain a separate storage for the largest value money items, or tokens that are not as necessary for making change.

In one or more embodiments, money items on the money item track 125 are used to make change rather than or with money items from the tubes 135. In this example embodiment, money items used as change from the money item track 125 are returned through the money item track exit 130 to a collection area.

The disclosed embodiments provide a solution for communication between the denominator, diverter gate, and money item receiver. The solution for communication can be a common bus with device to device communication, or a bus with a master processing device that provides a master/slave communication system with each component of the system.

Although FIG. 1A illustrates one example of a money item dispensing system 100a, various changes may be made to FIG. 1A. For example, the components of the money item dispensing system 100a are for illustration only. Various components in FIG. 1A could be omitted, combined, or further subdivided and additional components could be added according to particular needs.

FIG. 1B illustrates a money item dispensing system 100b with money items 150 released from the money item canister 105 according to various embodiments of the present disclosure. The money item dispensing system 100b can be part of money item dispensing system 100a as shown in FIG. 1A. The money item dispensing system 100b is contained within the chassis 102 shown in FIG. 1A. FIG. 1B does not limit the scope of this disclosure to any particular implementation of a money item dispensing system.

In an example embodiment, when change is to be dispensed, money items 150 are released from the money item canister 105 through slots 165 at the bottom of each tube 135. The money item canister 105 is designed such that the slots 165 of one or more tubes 135 align with the money item canister exit 155. In certain embodiments, the slots 165 of one or more tubes 135 are aligned with the money item canister exit 155 by a rotation of money item canister 105. In certain embodiments, the money items 150 are released from the tube 135 using an actuator. The actuator may apply pressure to the money item at the bottom of the stack of money items in tube 135. Once released, the money items 150 slide down the money item canister exit 155 to the collection area 160. The collection area 160 provides access to the returned money items 150 for the user.

In one or more embodiments, because the slots 165 from two or more tubes 135 are aligned with the money item canister exit 155, the money item canister only uses enough canister 105 positions to correspond to a number of total tubes 135 divided by the number of tubes 135 that are aligned with the exit 155. For example, if two of six tubes 135 are aligned with the exit 155 at the same time, then only three canister 105 positions are provided, which corresponds to half the total amount of tubes 135. In a similar example, four canister positions would exist in embodiments with eights total tubes 135 in the money item canister 105.

In various embodiments, the tubes 135 can be ordered based on the frequency or likelihood of requiring the corresponding money item 150 value when returning the change. For example, if quarter and pennies are the most common money items used when making change, one of the three canister positions could have a tube 135 with quarters and a tube 135 with pennies. In this example, because two tubes 135 are aligned at one time with the exit 155, only one canister 105 position may be necessary to make change when the change only requires quarters and pennies. In different embodiments, different combinations of denominations and numbers of aligned tubes can be used.

In embodiments where more than one money item of a single denomination are required for change, both of two aligned tubes 135 could contain the single denomination. Two tubes 135 with the same denomination would decrease the amount of time to return a large amount of same denomination money items by returning a money item from each of two tubes instead of two money items from a single tube.

Although FIG. 1B illustrates one example of a money item dispensing system 100b, various changes may be made to FIG. 1B. For example, the components of the money item dispensing system 100b are for illustration only. Various components in FIG. 1B could be omitted, combined, or further subdivided and additional components could be added according to particular needs.

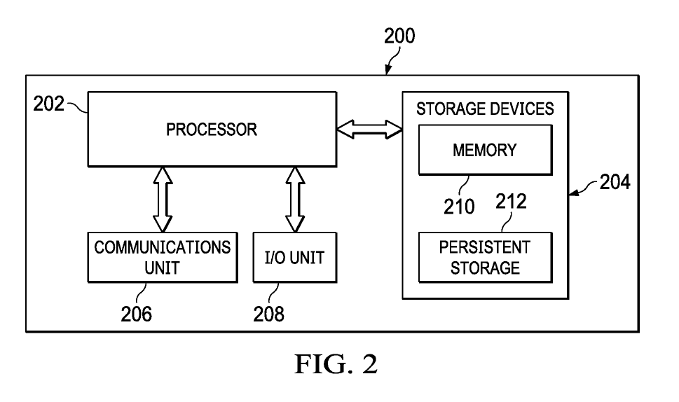

FIG. 2 illustrates an example computing device 200 supporting a money item dispensing system according to this disclosure. The device 200 could, for example, represent part of different devices shown in FIGS. 1A-1B and described above. For example, the device 200 could represent parts of a master processing device, denominator 110, diverter gate 115, and/or money item canister 105.

As shown in FIG. 2, the device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network. The communications unit 206 may support communications through any suitable physical or wireless communication link(s).

In certain embodiments, the communications unit 206 receives a signal containing the denomination of a money item 205. The communications unit 206 then transfers this data to the processor 202 which processes the signal. In certain embodiments, the processor 202 will transmit a signal to storage device 204. In certain embodiments, the processor 202 will transmit a signal to communications unit 206, which is then transmitted to diverter gate 115. In certain embodiments, the processor 202 will transmit a signal to communications unit 206, which is then transmitted to money item canister 105.

The I/O unit 208 allows for input and output of data. For example, the I/O unit 208 may provide a connection for user input through a keyboard, mouse, keypad, touchscreen, or other suitable input device. The I/O unit 208 may also send output to an actuator or other suitable device.

Although FIG. 2 illustrates one example of a device 200 supporting communication between the denominator, diverter gate, and money item receiver in a money item dispensing system, various changes may be made to FIG. 2. For example, various components in FIG. 2 could be combined, further subdivided, or omitted and additional components could be added according to particular needs. Also, computing devices can come in a wide variety of configurations, and FIG. 2 does not limit this disclosure to any particular configuration of computing device. The device 200 can be a representation of components used within each of a denominator, diverter gate, money item receiver, canister, a master processing device.

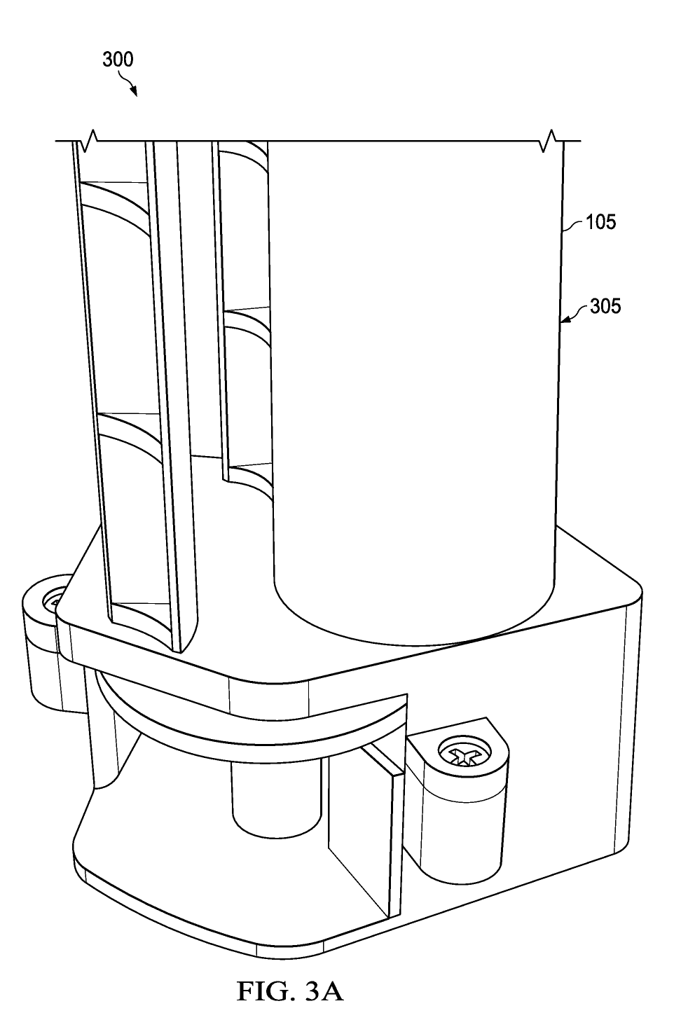

FIGS. 3A and 3B illustrate a money item canister 105 according to various embodiments of the present disclosure. The embodiment of the money item canister 105 illustrated in FIGS. 3A and 3B are for illustration only. FIGS. 3A and 3B do not limit the scope of this disclosure to any particular implementation of a money item dispensing system.

In FIGS. 3A and 3B, canister 105 includes release mechanism 305. Release mechanism 305 can be a device that assists in the release of the money items to exit the canister 105.

Canister 105 also includes openings 315. The openings 315 allow money items to enter the tubes 135 of canister 105. Once in the tube 135, the money items may stack within the tube 135.

As shown in this example, slots 165 of two tubes 135 are aligned. However, in different examples, different numbers of tubes may be aligned.

Although FIGS. 3A-3B illustrate one example of a money item canister 105 supporting a money item dispensing system 100, various changes may be made to FIGS. 3A-3B. For example, various components in FIGS. 3A-3B could be combined, further subdivided, or omitted and additional components could be added according to particular needs. Also, computing devices can come in a wide variety of configurations, and FIGS. 3A-3B do not limit this disclosure to any particular configuration of computing device.

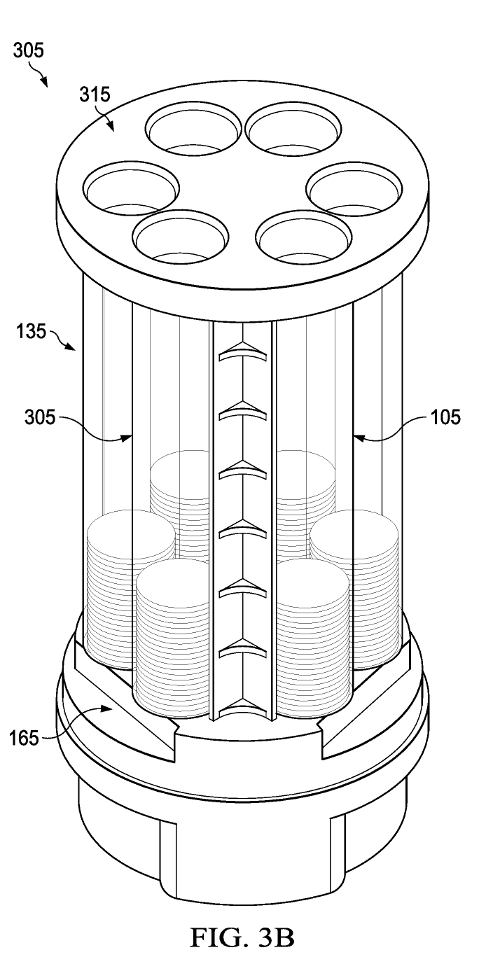

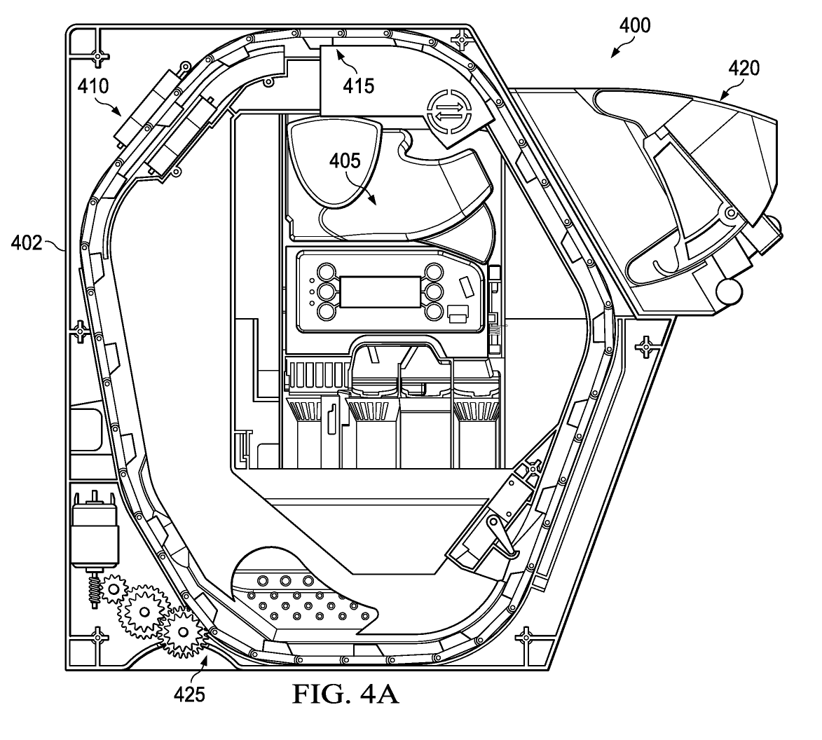

FIG. 4A illustrates a money item dispensing system 400 with a multiple tube manifold sorter 405 according to various embodiments of the present disclosure. The embodiment of money dispensing system 400 illustrated in FIG. 4A is for illustration only. FIG. 4A does not limit the scope of this disclosure to any particular implementation of a money item dispensing system. Different components of money item dispensing system 400 could use device 200 of FIG. 2 to perform processing operations and communications with other components. In another embodiment, system 400 includes a master processing device that is within chassis 402 or external to chassis 402. The master processing device can control operations and communications between components of system 400a.

The money item dispensing system 400 includes the chassis 402, a multiple tube manifold sorter 405, a denominator 410, a diverter gate 415, a validator 420, and a money track 425. In certain embodiments, the money item dispensing system 400 is contained within the chassis 402. The money item dispensing system 400 receives money items and returns change in money items. The money item dispensing system 400 is designed with multiple solenoid/motor driven gates integrated into the multiple tube manifold sorter 405. The money item can be a coin, token, slug, washer or any other item that could be used in an attempt to operate a money item operated device or system.

The money items received by the money item dispensing system 400 are separated and transported using the money item track 425. The money item track 425 travels around the inside perimeter of the money item dispensing system 400. The side of the money item track 425 facing inward has a plurality of bumps, or grooves, that catch a money item inserted into the money item dispensing system 400. When a large amount of money items is inserted the bumps in the money item track 425 are configured to separate and transport each money item separately.

The money item track 425 processes each money item through the denominator 410 to determine the denomination of each money item. The money item dispensing system 400 is programmed with profiles for the money items to identify the denominations as they pass through the denominator 410. The denominator 410 transmits the denomination of each money item to the multiple tube manifold sorter 405. The diverter gate 415 redirects the money item off from the money item track 425 into the multiple tube manifold sorter 405. In one example embodiment, the diverter gate 415 redirects only certain money items from the track 425 and allows other money items to remain on the track 425.

FIG. 4B illustrates the use of multiple solenoids 440a-d to sort money items in a multiple tube manifold sorter 405 from single diverter gate 415 according to an embodiment of this disclosure. The embodiment of the multiple tube manifold sorter 405 illustrated in FIG. 4B is for illustration only. FIG. 4B does not limit the scope of this disclosure to any particular implementation of a multiple tube manifold sorter.

The process depicted in FIG. 4B may be performed by implementing four solenoids to sort money items to seven paths. Each path would lead to a separate tube 135. In one embodiment, the multiple tube manifold sorter 405 of FIG. 4B may be used as an alternative to the money item canister 105 in the money item dispensing system 100 of FIG. 1. In certain embodiments, multiple tube manifold sorter 405 could have more or less than four solenoids sorting to more or less than seven different paths.

Although FIG. 4B illustrates one example of a sorting system for multiple tube manifold sorter 405, various changes may be made to FIG. 4B. For example, the components of multiple tube manifold sorter 405 are for illustration only. Various components in FIG. 4B could be omitted, combined, or further subdivided and additional components could be added according to particular needs. The disclosed embodiments provide a solution for communication between the denominator, diverter gate, and money item receiver. The solution for communication can be a common bus with device to device communication, or a bus with a master processing device that provides a master/slave communication system with each component of the system.

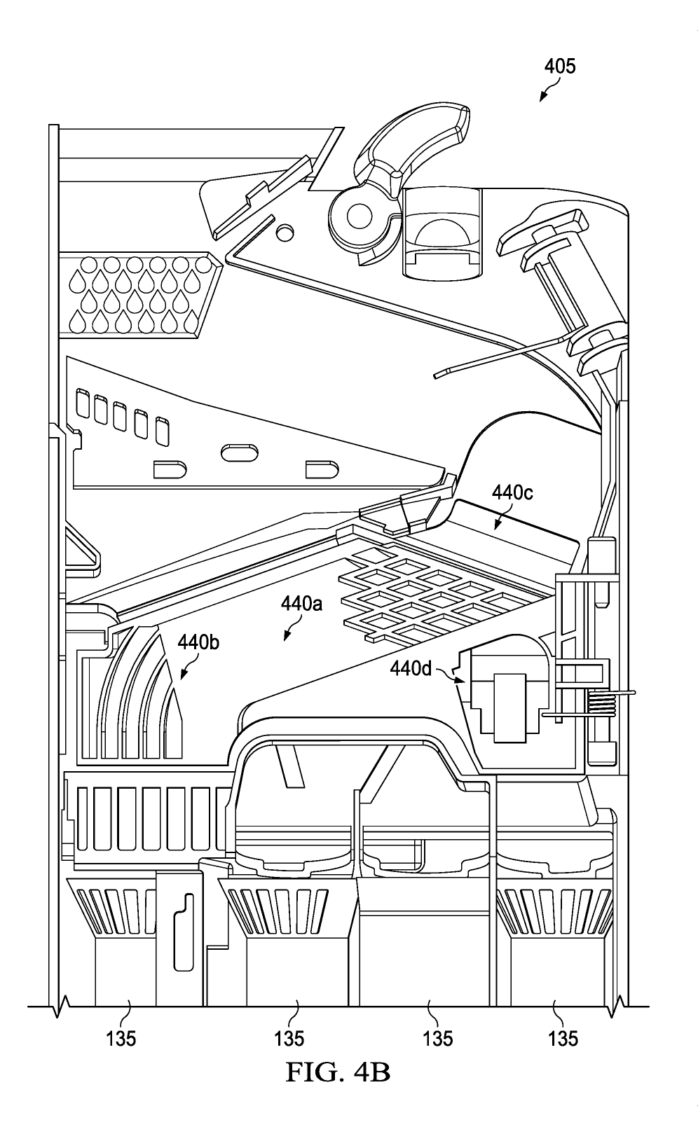

FIG. 5 illustrates an example process 500 accepting money items using a money item dispensing system according to various embodiments of the present disclosure. For example, the process depicted in FIG. 5 may be performed by money item dispensing system 100 in FIGS. 1A-lB.

In operation 510, the money item dispensing system 100 receives one or more money items 150. The money items 150 can be coins, tokens, slug, washers or any other item that could be used in an attempt to operate a money item operated device or system. The money item dispensing machine 100 moves the money items 150 using a money item track 125 as shown in FIG. 1. The money item track 125 is configured to separate the money items 150 and transport the money items 150 individually.

In operation 520, a processor determines a denomination of the received money item. The money item track 125 transports the money items 150 through the denominator 110. The denominator 110 determines the denomination of the money items 150. The processor sends a signal from the denominator 110 to the diverter gate 115 and the money item canister 105. The money item dispensing system 100 receives, at the money item canister 105 and/or the diverter gate 115, the denomination of the received money item 150.

In operation 530, a processor aligns a tube 135 corresponding to the denomination with a diverter gate 115. In certain embodiments, a tube 135 as shown in FIG. 1B is used as a tube 135 as shown in FIG. 1. After the money item canister 105 receives the signal from denominator 110, a motor 145a rotates the money item canister 105 to align a tube 135 with the corresponding diverter gate 115. The money item canister 105 includes a plurality of tubes 135 corresponding to different denominations of money items. Multiple tubes 135 in a money item canister 105 can correspond to a specific denomination of money items 150.

In operation 540, the processor adjusts (i.e., open) the diverter gate 115 to create a path to the tube 135 corresponding to the denomination of the money item 150. The diverter gate 115 is controlled to only create a path for the money item 150 with a denomination corresponding to the denomination of money items 150 stored in a particular tube 135. Money items 150 that do not correspond to the denomination of the tube 135 are not diverted by adjusting the diverter gate 115 and remain on the money item track 125.

In operation 550, the processor controls a reception of the money item 150 in the tube 135 corresponding to the denomination of the money item 150. The diverter gate 115 diverts the money item 150 from the money item track 125 into the tube 135 corresponding to the denomination of the money item 150.

Although FIG. 5 illustrates an example process for accepting money items using a money item dispensing system various changes could be made to FIG. 5. For example, while shown as a series of steps, various steps could overlap, occur in parallel, occur in a different order, or occur multiple times.

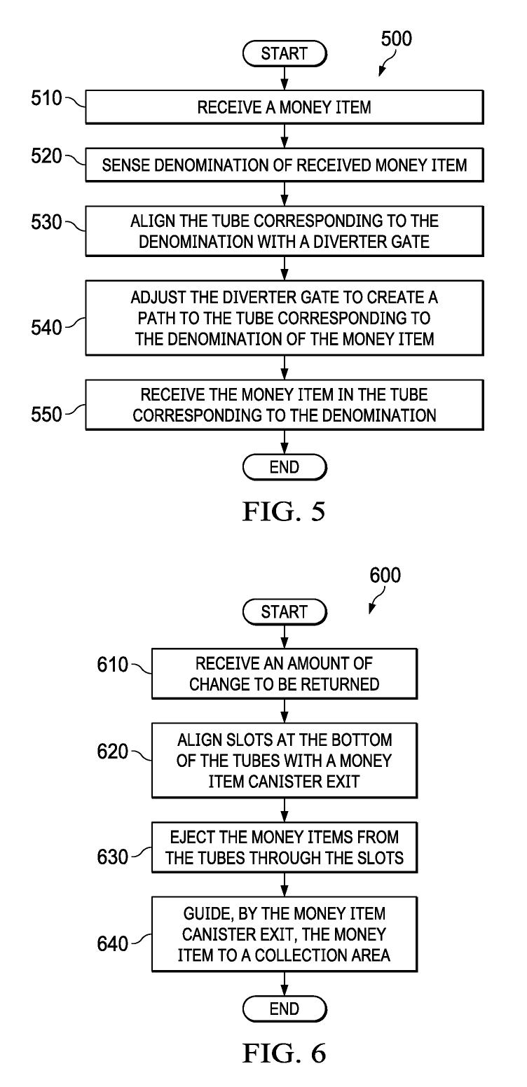

FIG. 6 illustrates an example process 600 returning money items using a money item dispensing system according to various embodiments of the present disclosure. For example, the process depicted in FIG. 6 may be performed by money item dispensing system 100 in FIGS. 1A-1B.

In operation 610, the processor is configured to receive an input of an amount of change to be returned to a user. The amount of change can be based on the amount of money items 150 received less a cost of goods.

In operation 620, the processor aligns the slots 165 at a bottom 136 of the tubes 135 with a money item canister exit 155 via a motor 145a. The slots 165 are large enough to allow at least one money item 150 to be ejected from the tube 135. The money item canisters 105 are structured with the slots 165 of two adjacent tubes 135 aligned with the money canister exit 155. The money item canister 105 has a minimum amount of rotatable positions aligning with the money item canister exit 155 corresponding to half the amount of tubes 135 in the canister money item canister 105.

In operation 630, the processor ejects the money items 150 from the tubes 135 through the slots 165. The ejection can occur with using any ejection method including, for example, gravity or an actuator. In operation 640, the money item dispensing system 100 guides, by the money item canister exit 155, the money item 150 to a collection area 160.

Although FIG. 6 illustrates an example process for returning money items using a money item dispensing system, various changes could be made to FIG. 6. For example, while shown as a series of steps, various steps could overlap, occur in parallel, occur in a different order, or occur multiple times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, “A and B”, “A and C”, “B and C”, and “A and B and C”.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A money item dispensing apparatus comprising:
a money item track operable to receive a money item and transport the money item;
a denominator configured to determine a denomination of the money item on the money item track;
a rotatable money item canister operable to receive the money item in a tube of a plurality of tubes; and
a diverter gate configured to, based on the denomination, divert the money item to the tube, the tube corresponding to the denomination of the money item.

2. The money item dispensing apparatus of claim 1, further comprising:
a single path leading from the diverter gate to the plurality of tubes.

3. The money item dispensing apparatus of claim 1, further comprising a processor configured to:
responsive to receiving an input to dispense a set of money items, determine one or more denominations of money items corresponding to the set of money items;
rotate the money item canister to align slots of two or more tubes corresponding to the one or more denominations, positioned at a bottom of two or more of the plurality of tubes of the money item canister, with a money item canister exit; and
eject the set of money items from the slots of the two or more tubes aligned with the money item canister exit.

4. The money item dispensing apparatus of claim 1, wherein the rotatable money item canister is configured to rotate a predetermined number of degrees around a vertical axis.

5. The money item dispensing apparatus of claim 1, wherein the denominator is further configured to, based on the denomination, allow the money item to remain on the money item track.

6. The money item dispensing apparatus of claim 1, wherein the rotatable money item canister is operable to rotate at a predetermined number of positions that is less than a number of the plurality of tubes.

7. The money item dispensing apparatus of claim 6, wherein each of the plurality of tubes includes a slot where the money item exits, and wherein two or more slots of the plurality of tubes are aligned with a money item canister exit at each of the number of positions.

8. An apparatus comprising:
a memory element; and
a processor coupled to the memory element, the processor configured to:
control a money item track to transport a money item;
receive, from a denominator, a denomination of the money item when the money item passes the denominator on the money item track;
control a rotatable money item canister to rotate based on the denomination of the money item, wherein the rotation aligns a tube of a plurality of tubes of the rotatable money item canister; and
control a diverter gate to divert the money item to the rotatable money item canister.

9. The apparatus of claim 8, wherein the money item is diverted onto a single path from the diverter gate to the plurality of tubes.

10. The apparatus of claim 8, wherein the processor is further configured to:
responsive to receiving an input to dispense a set of money items, determine one or more denominations of money items corresponding to the set of money items;
rotate the rotatable money item canister to align slots of two or more tubes corresponding to the one or more denominations, positioned at a bottom of two or more of the plurality of tubes of the rotatable money item canister, with a money item canister exit; and
eject the set of money items from the slots of the two or more tubes aligned with the money item canister exit.

11. The apparatus of claim 8, wherein the rotatable money item canister is configured to rotate a predetermined number of degrees around a vertical axis.

12. The apparatus of claim 8, wherein the processor is further-configured to, based on the denomination, allow the money item to remain on the money item track.

13. The apparatus of claim 8, wherein the rotatable money item canister is operable to rotate at a predetermined number of positions that is less than a number of the plurality of tubes.

14. The apparatus of claim 13, wherein each of the plurality of tubes includes a slot where the money item exits, and wherein two or more slots of the plurality of tubes are aligned with a money item canister exit at each of the number of positions.

15. A method for dispensing money items comprising:
transporting, on a money item track, a money item;
identifying a denomination of the money item when the money item passes the denominator on the money item track;
rotating a rotatable money item canister based on the denomination of the money item, wherein the rotation aligns a tube of a plurality of tubes of the rotatable money item canister; and
diverting the money item to the rotatable money item canister.

16. The method of claim 15, wherein the money item is diverted onto a single path from the money item track to the plurality of tubes.

17. The method for of claim 15, further comprising:
determining one or more denominations of money items corresponding to a set of money items in response to receiving an input to dispense the set of money items;
rotating the money item canister to align slots of two or more tubes corresponding to the one or more denominations, positioned at a bottom of two or more of the plurality of tubes of the money item canister, with a money item canister exit; and
ejecting the set of money items from the slots of the two or more tubes aligned with the money item canister exit.

18. The method of claim 15, wherein rotating the money item canister comprises rotating the money item canister a predetermined number of degrees around a vertical axis.

19. The method of claim 15, further comprising:
allowing the money item to remain on the money item track based on the denomination.

20. The method of claim 15, wherein rotating the money item canister comprises rotating the money item canister at a predetermined number of positions that is less than a number of the plurality of tubes.
